(19) United States
(12) Patent Application Publication
(10) Pub. No.: US 2006/0090187 A1
(43) Pub. Date: Apr. 27, 2006

(54) Rtsp-based multimedia control method

(75) Inventors: Sang-Ho Chae, GYEONGGI-DO (KR); Joong-Yun Lee, Seoul (KR); Sang-Woo Rhie, Seoul (KR); Hyun-Joong Park, Seoul (KR); Hee-Won Park, Gyeonggi-do (KR); Hung-Seo Yun, Daejeon (KR); Won-Hee Sull, Gyeonggi-do (KR); Dong-Won Na, Gyeonggi-do (KR)

Correspondence Address: RATNERPRESTIA, P O BOX 980, VALLEY FORGE, PA, 19482-0980, US

(73) Assignee: SK TELECOM CO., LTD., SEOUL (KR)

(21) Appl. No.: 10/547,352

(22) PCT Filed: Dec. 27, 2004
(86) PCT No.: PCT/KR04/03455

§ 371 Date: Aug. 29, 2005

(30) Foreign Application Priority Data
Dec. 27, 2003 (KR) 10-2003-0098116
Dec. 30, 2003 (KR) 10-2003-0100179

(51) Int. Cl. H04N 7/173

(52) U.S. Cl. 725/100; 709/219

(57) ABSTRACT

A method for controlling multimedia based on RTSP is disclosed. The method comprises the steps of: a) confirming a state of a multimedia terminal when a user of the multimedia terminal selects a multimedia play; b) generating a PLAY message of requesting selected media data based on the result of step a) and transmitting the PLAY message to a media server through a wireless data communication network; c) determining whether the state of the multimedia terminal is varied after step b); and generating a control message corresponding to the varied state when the state of the multimedia terminal is varied and transmitting the control message to the server.

### TECHNICAL FIELD

The present invention relates to a method for controlling multimedia based on a real time streaming protocol (RTSP), and more particularly to a method for dynamically controlling multimedia based on RTSP, wherein a control command is generated based on RTSP from a multimedia terminal when a multimedia service is provided through a wireless data communication network, and then media data are provided to the multimedia terminal.

### BACKGROUND ART

Currently, a subscriber can receive a variety of multimedia services by use of a multimedia terminal through a wireless data communication network. The multimedia service means the reception of a wide variety of data through a wireless data communication network. The fees for the multimedia service in the wireless data communication network are usually charged based on packets of data. Accordingly, if a subscriber receives a multimedia service such as moving pictures through the wireless data communication network, the subscriber pays a considerable fee to a service provider. In terms of the network, since even media data which a user does not want are transmitted, there is a disadvantage that the general efficiency of the network is decreased.

When using a multimedia service, it is frequent not to use all of the received media data according to the surrounding environments. For example, a user turns off audio output, and plays back only video data in public places. However, in a current moving picture service, both video and audio data constituting the moving pictures are always provided to an RTSP terminal, and the AUDIO OFF is embodied by selecting a menu of the media player installed at the terminal. This is because the terminal cannot control the constitution of contents to be received when it receives a multimedia service. Accordingly, a user receives unnecessary data, and thus must pay the fee for the reception of unused data.

Thus, while media data are being transmitted through the wireless data communication network, a new method is needed to allow the user to receive only the media data which the user desires to play back, and for recognizing and transmitting media data which the user can receive.

### DISCLOSURE OF INVENTION

An object of the present invention is to provide a method for dynamically controlling multimedia based on RTSP which allows the user to control multimedia data to be received during the reception of media data through a wireless data communication network.

To achieve the above object, a method for controlling multimedia based on RTSP in a multimedia terminal according to one aspect of the present invention comprises the steps of:

(a) confirming the state of the multimedia terminal if a user of the multimedia terminal selects a playback of multimedia;

(b) generating a PLAY message requesting the selected multimedia data based on the confirmation result in step (a), and transmitting the PLAY message to a media server through a wireless data communication network;

(c) determining whether the state of the multimedia terminal is changed after step (b); and

(d) generating a control message corresponding to the changed state when the state of the multimedia terminal is changed, and transmitting the control message to the media server.

The control message is preferably transmitted through a SET_PARAMETER. However, the control message can be embodied by the SET_PARAMETER of RTSP as well as by the combination or modification of other commands (Play, Stop, Connect, etc.) or methods. Although the present invention presents the SET_PARAMETER as an example, it should be noted that its function can be replaced by a variety of commands using RTSP or the combination thereof.

Preferably, the state of the multimedia terminal includes a vibration mode or a display mode of phone.

More preferably, if it is determined in step (a) that the state of the multimedia terminal is in a mode where a user cannot see the screen of the multimedia terminal, it generates a the PLAY message requesting to exclude video data from the multimedia data. If it is determined in step (a) that the state of the multimedia terminal is in a vibration mode, it generates a PLAY message requesting to exclude audio data from the multimedia data.

Also preferably, the SET_PARAMETER message includes a message of controlling each of at least one media constituting the multimedia.

Also preferably, if it is determined in step (c) that the state of the multimedia terminal is changed to a vibration mode or a vibration-off mode, the SET_PARAMETER message generated in step (d) requests the stop or start of the transmission of audio data.

Also preferably, if it is determined in step (c) that the state of the multimedia terminal is changed to a visible or invisible mode, the SET_PARAMETER message generated in step (d) requests the stop or start of the transmission of video data.

Also preferably, the SET_PARATER message includes at least one parameter defined for controlling the media.

A method for distributing multimedia data based in a wireless data communication network according to RTSP according to a second aspect of the present invention comprises the steps of:

(a) transmitting multimedia data, which a multimedia terminal requested according to RTSP, to the multimedia terminal through a wireless data communication network; and

(b) while the multimedia data are being transmitted to the multimedia terminal in step (a), if a command for controlling the multimedia data is generated from the multimedia terminal, reconstructing the multimedia data according to the command, and transmitting the reconstructed multimedia data to the multimedia terminal.

Preferably, the command is provided through the SET_PARAMETER message, and the command includes a request for the stop or start of the transmission of the media data. Also, the command is defined by at least one parameter of the SET_PARAMETER.

Also preferably, the media data includes at least one among video file, audio file and text file, and the command includes a request for the stop or start of the transmission of each of the video file, audio file and text file.

In a third aspect of the present invention, a method for distributing multimedia data according to RTSP in a wireless data communication network comprises the steps of:

(a) receiving a media request at a media server from a multimedia terminal;

(b) if the request is received from the multimedia terminal, transmitting the requested media data to the multimedia terminal; and

(c) while the multimedia data are being transmitted to the multimedia terminal in step (b), if a command for controlling the multimedia data is generated from the multimedia terminal, controlling the multimedia data according to the command, wherein the command is provided through the SET_PARAMETER; the multimedia data include at least one among video, audio and text; and the command includes a request for the stop or start of the transmission of each of the video, audio and text.

Preferably, the multimedia terminal transmits the command, and retransmits the command if there is no response to the command for a predetermined period of time. If the retransmission is repeated for a predetermined number of times, the transmission of the command is disregarded.

Also preferably, the command is defined by at least one parameter of the SET_PARAMETER.

In a fourth aspect of the present invention, a method for controlling multimedia based on RTSP in a wireless data communication network comprises the steps of:

(a) confirming the state of the multimedia terminal if a user of a multimedia terminal selects a playback of multimedia;

(b) generating a PLAY message requesting the selected multimedia data based on the confirmation result in step (a), and transmitting the PLAY message to a media server through a wireless data communication network;

(c) message if the media server receives the PLAY message from the multimedia terminal, transmitting the multimedia data from the media server to the multimedia terminal according to the PLAY;

(d) determining whether the state of the multimedia terminal is changed after step (b);

(e) generating a SET_PARAMETER message corresponding to the changed state, and transmitting the SET_PARAMETER message to the media server, if the state of the multimedia terminal is changed as a result of the determination in the step (d); and

(f) controlling the multimedia data according to the SET_PARAMETER message while the multimedia data are being transmitted to the multimedia terminal in step (c), if the SET_PARAMETER message is received at the media server.

Preferably, the state of the multimedia terminal includes a vibration. mode or a display mode of phone.

Also preferably, if it is determined in step (a) that the state of the multimedia terminal is in a mode where a user cannot see the screen, it generates a PLAY message requesting to exclude video data from the multimedia data; and if it is determined in step (a) that the state of the multimedia terminal is in a vibration mode, it generates a PLAY message requesting to exclude audio data from the multimedia data.

Also preferably, the SET_PARAMETER message includes a command of controlling each of at least one media constituting the multimedia data, and if it is determined in step (d) that the multimedia terminal is changed to a vibration mode or a vibration-off mode, the SET_PARAMETER message generated in step (e) is a message requesting the stop or start of the transmission of video media.

More preferably, the SET_PARAMETER message includes at least one parameter defined for controlling the media.

According to the present invention, while a user receives a multimedia service through a wireless data communication network, the user receives only the data which he/she wants according to the environment, thereby preventing the charge for the reception of unnecessary data.

### BRIEF DESCRIPTIONS OF THE DRAWINGS

The invention will be further understood from the following detailed description of a preferred embodiment, taken in conjunction with the accompanying drawings.

FIG. 1 shows an example of a system to which a method for dynamically controlling multimedia based on RTSP according to the present invention is applied.

FIG. 2 is a flow chart showing a method for controlling multimedia based on RTSP at a multimedia terminal according to a first embodiment of the present invention.

FIG. 3 is a flow chart showing a method for controlling multimedia based on RTSP at a multimedia terminal according to a second embodiment of the present invention.

FIG. 4 is a flow chart showing a method for controlling multimedia based on RTSP at a multimedia terminal according to a third embodiment of the present invention.

FIG. 5 is a flow chart of signals showing a method for controlling multimedia based on RTSP at a multimedia terminal according to a fourth embodiment of the present invention.

FIG. 6 is a flow chart showing the process of the retransmission of a SET_PARAMETER message in FIG. 5.

### DETAILED DESCRIPTION OF THE PREFERRED EMBODIMENT

Hereinbelow, embodiments of the invention will now be described by way of example with reference to the. accompanying drawings.

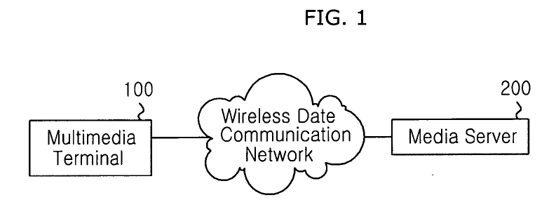

FIG. 1 shows an example of a system to which a method for dynamically controlling multimedia based on RTSP according to the present invention.

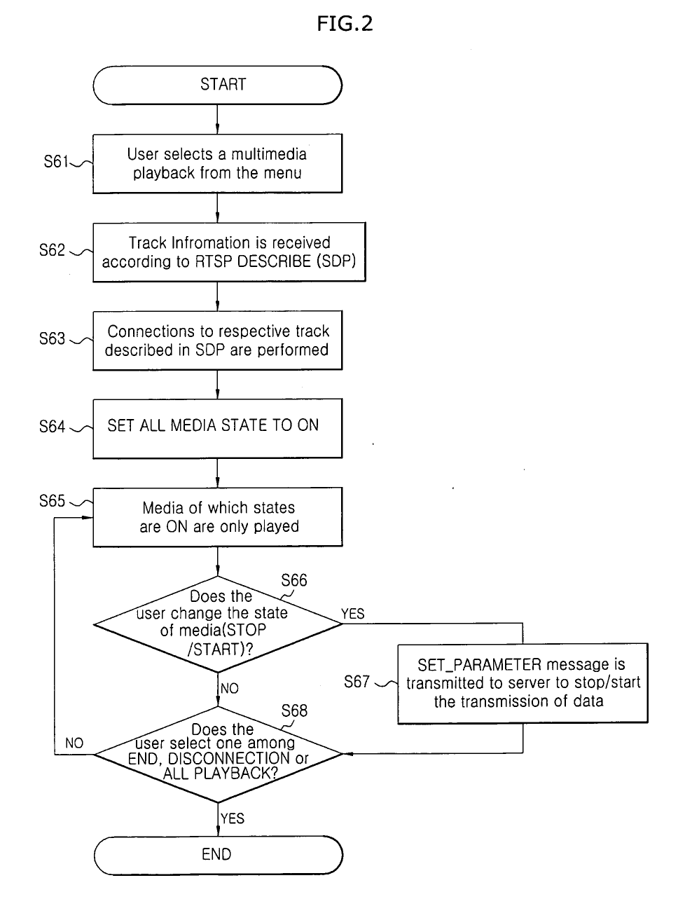

FIG. 2 is a flow chart showing a method for controlling multimedia based on RTSP at a multimedia terminal according to a first embodiment of the present invention.

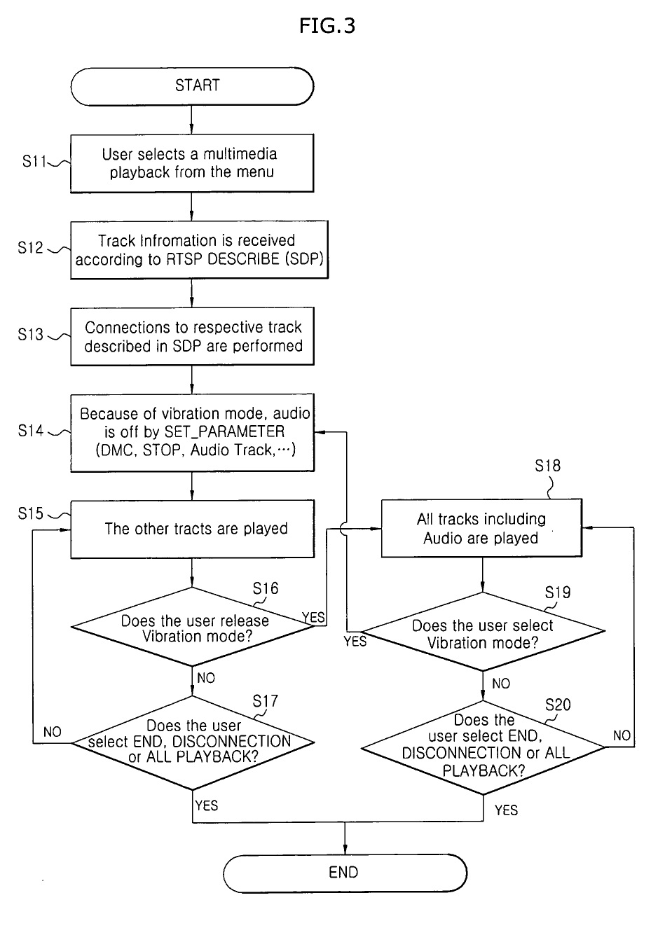

FIG. 3 is a flow chart showing a method for controlling multimedia based on RTSP at a multimedia terminal according to a second embodiment of the present invention.

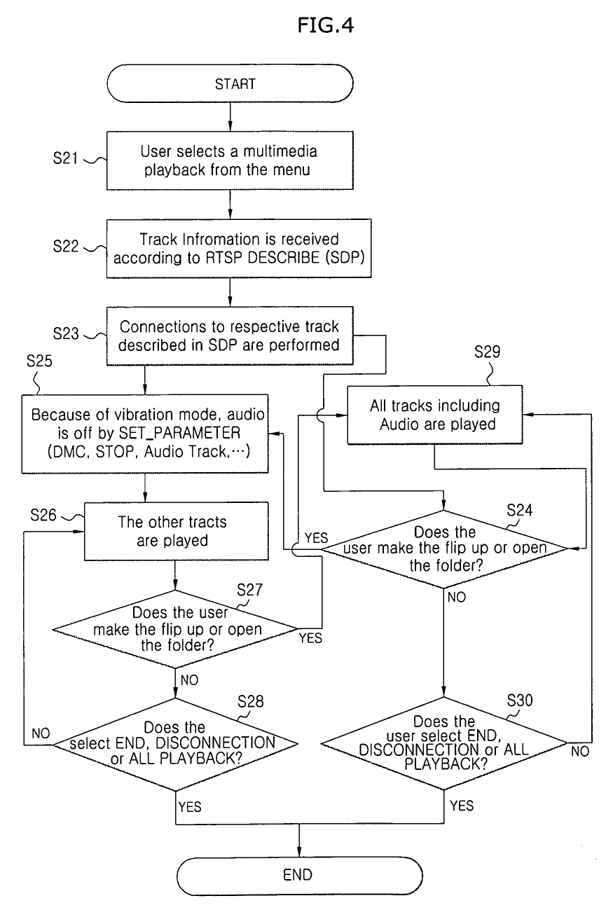

FIG. 4 is a flow chart showing a method for controlling multimedia based on RTSP at a multimedia terminal according to a third embodiment of the present invention.

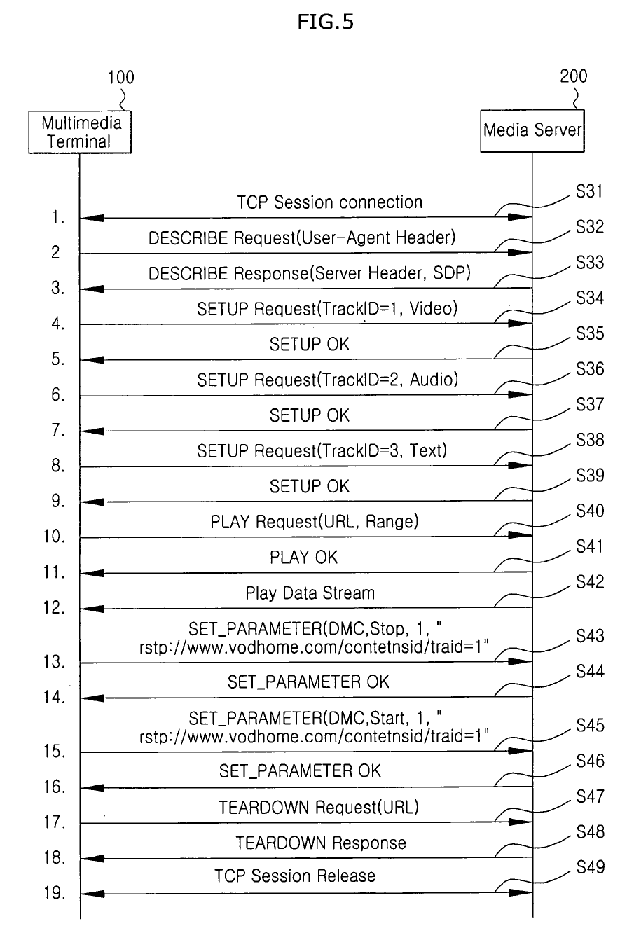

FIG. 5 is a flow chart of signals showing the process of the retransmission of the SET_PARAMETER message in FIG. 4.

The embodiments presume an environment where a streaming session is controlled according to RTSP (Real Time Streaming Protocol), and each streaming data are transmitted according to RTSP.

A multimedia terminal 100, to which the method according to the present invention is applied, requests a media server 200 for contents according to RTSP. In response to the request, the media server 200 provides the media data of the requested contents to the RTSP terminal 100 through a wireless communication network. During the reception of the media data, the multimedia terminal 100 generates a command based on RTSP for controlling the media data transmission of the media server 200, and transmits the command to the media server 200 according to RTSP. Then, the media server 200 controls the transmission of each of the media data according to the command.

The command according to the present invention is defined according to a SET_PARAMETER of RTSP. An example of the definition of the SET_PARAMETER according to the present invention is shown in Table 1 below.

TABLE 1

| | Field | | |
|---|---|---|---|
| Order | Name | Value Range | Remark |
| 1 | AppClass | DMC | Relevant Service |
| 2 | OpCode | Stop: Request for the stop of data | |
| | | transmission to an RTP | |
| | | connection corresponding to a | |
| | | certain media | |
| | | Start: Request for the start of data | |
| | | transmission to an RTP | |
| | | connection corresponding to a | |
| | | certain media | |
| 3 | TrackID | Track ID defined at SETUP | |
| 4 | URL | Rtsp URL | Rtsp URL |

Table 2, below, shows an example of the generation of a command of the SET_PARAMETER message according to the definition in Table 1 at the multimedia terminal 100 and the response of the media server 200.

TABLE 2

```
C→S: SET PARAMETER  rtsp://example.com/fizzle/foo
    Cseq: 421
    Content-length: 73
    Content-type: text/parameters
    AppClass: DMC
    OpCode: Stop
    TrackID: 1
    URL: “rtsp://www.nate.com/video/trackID=1”
S→C:RTSP/1.0 200 OK
    Cseq: 421
    Content-Length: 32
    Content-Type: text/parameters
    AppClass: DMC
    OpCode: Stop
    TrackID: 1
```

The SET_PARAMETER message shown in Table 2 requests the media server 200 for the stop of the data transmission of TrackID: 1, and the media server provides media data, excluding the data of TrackID: 1, to the multimedia terminal 100 according to the SET_PARAMTER message. Preferably, the multimedia terminal 100 is programmed so as to generate a SET_PARAMETER message according to a user's selection. A person skilled in the art will understand that the present invention is not limited by the programming method of the multimedia terminal 100.

The multimedia terminal 100 establishes sessions with respect to each media constituting the contents according to RTSP in order to receive the contents, and if the multimedia terminal 100 requests the media server 200 for each media constituting the contents, the media server 200 streams each media data of the contents to the multimedia terminal 100 in response to the request. Thereafter, if the state of the multimedia terminal 100 is changed while playing back the contents according to the present invention, the multimedia terminal 100 generates a SET_PARAMETER message corresponding to the changed state, and transmits the SET_PARATER message to the media server 200. For example, if the state of the multimedia terminal 100 is changed to a vibration mode or a vibration-off mode, the multimedia terminal 100 provides a SET_PARAMETER message requesting the stop or start of the transmission of audio media to the media server 200, so that the media 200 can stop or start the transmission of audio data. Also, if the state of the multimedia terminal 100 is changed to a window-close or a window-open mode, the multimedia terminal 100 transmits a SET_PARAMETER message requesting the stop or start of the transmission of video media to the media server 200, so that the media server 200 can stop or start the transmission of video media.

Hereinafter, the method for controlling multimedia based on RTSP at a multimedia terminal according to the present invention will be explained with reference to the accompanying drawings in detail.

Referring to FIG. 2, the processes that a user controls media as the playback state of each media of the multimedia terminal 100 is changed.

If a user selects a multimedia playback from the menu of the multimedia terminal 100, the multimedia terminal 100 transmits an RTSP DESCRIBE (SDP) message at a TCP session to request the description of the contents (multimedia) which the user selected. Then, the media server 200, in response to the DESCRIBE message, provides the description of the contents to the multimedia terminal 100 (S61-S62).

The multimedia terminal 100, which received the DESCRIBE response from the media server 200, transmits respective SETUP request message to the media server 200 according to the description of the contents in order to request respective track of all media, for example, video of TrackID: 1, audio of TrackID: 2, and text of TrackID: 3. Then, in response to each of the SETUP request message, the media server 200 provides the multimedia terminal 100 with Transport Mechanisms to be used to distribute the requested media. If the SETUP message response of the media server 200 is received, the multimedia terminal 100 transmits a PLAY message of requesting to transmit the media through the mechanism defined in the SETUP. Then, the media server 200 provides the requested media stream to the multimedia terminal 100 in response to the PLAY message (S63-S65).

During the playback of the media, there may be a case where the user needs to stop the playback of a specific media (or to start the playback if a specific media is stopped). In such case, the user changes the state of media, which the user desires to stop the playback (or to start the playback), from the playback mode to the stop mode (or from the stop mode to the start mode). As such, the designation of the change (stop/start) of the state during the media playback of the multimedia terminal 100 can be embodied in such a manner that the multimedia terminal 100 recognizes the multimedia type which was defined at the initial setting and connects the multimedia type with a track ID, so the user can select the stop/start at a pop-up menu at the bottom of the playback screen of the multimedia terminal 100. Also, in case of the control according to the state of the terminal and the playback, the control menu may be disabled. For example, in case of the contents without a specific media, it is preferable to exclude such contents from the menu items or disable them. That is, if a specific terminal has video, audio and text, since the initial menu can selects the change from an “ON” state to an “OFF” state, it is preferable that “VIDEO OFF,” “AUDIO OFF” and “TEXT OFF” items appear. If the video playback is “OFF,” it is preferable that “VIDEO ON,” “AUDIO OFF” and “TEXT OFF” items appear (S66).

If the user changes the playback state (stop or start) of a specific media during the playback of the media, the multimedia terminal 100 generates a SET_PARATER message corresponding to the state change according to the present invention, and transmits the SET_PARAMETER message to the media server 200. Then, the media server 200 stops the transmission of the corresponding media according to the SET_PARAMETER message. Also, the stop of the media transmission is maintained unless the state of the corresponding media is changed (S67, S68).

Now the process of controlling the media in case that the multimedia terminal 100 is set in a vibration mode will explained with reference to FIG. 3.

At the step S11, if the user selects the multimedia playback from the menu of the multimedia terminal 100, the multimedia terminal 100 transmits a DESCRIBE message at the TCP session to request the description of the contents (multimedia) selected by the user. Then, in response to the DESCRIBE message, the media server 200 provides the description of the contents to the multimedia terminal 100 (S11-S12).

The multimedia terminal 100, which has received the response to the DESCRIBE message, requests the media constituting the contents according to the description of the contents and the state of the multimedia terminal 100. At this time, since the state of the multimedia terminal 100 is in a vibration mode, the multimedia terminal 100 generates a SET_PARAMETER message of “AUDIO OFF” command, and provides the SET_PARAMETER message of “AUDIO OFF” command to the media server 100 to thereby suspend the transmission of the audio data of the contents of the media server 200 (S13 and S14).

According to the request, the multimedia terminal 100 receives the media data of the contents excluding the audio data and plays back the media data. During the playback, if the user releases the vibration mode, the multimedia terminal 100 transmits a SET_PARAMETER message, which commands “AUDIO ON” according to the release of the vibration mode, to the media server 200. Then, the media server 200 transmits a stream including the audio data to the RTSP terminal in response to the SET_PARAMETER message, so that the audio data of the contents are played back (S15, S16, S18).

Subsequently, if the user selects the vibration mode again, the multimedia terminal 100, like the step S14, transmits the SET_PARANETER message again to turn off audio. If no change of mode is made, the current state is maintained until the playback of the contents ends (S17, S18, S19).

FIG. 4 shows the process of controlling media according to the “VIDEO OFF” mode of the multimedia terminal 100.

At the step S21, if the user selects the multimedia playback from the menu of the multimedia terminal 100, the multimedia terminal 100 transmits the DESCRIBE message at the TCP session to request the description of the contents (multimedia) selected by the user. Then, in response to the DESCRIBE message, the media server 200 provides the description of the contents to the multimedia terminal 100 (S21-S22).

The multimedia terminal 100, which has received the response of the DESCRIBE message, requests the media constituting the contents according to the description of the contents and the current state of the multimedia terminal 100. At this time, since the current state of the multimedia terminal 100 is the “VIDEO OFF” mode (for example, the flip down state if the terminal is a flip type; the folded state if the terminal is a folder type), the multimedia terminal 100 generates a SET_PARAMETER message of the “VIDEO OFF” command and provides the SET_PARAMETER message of the “VIDEO OFF” command to the media server 200 to suspend the transmission of the video date of the contents (S23-S25).

According to the media request, the multimedia terminal 100 receives and plays back the media data of the contents excluding the video data. During the playback, if the user changes the state of the multimedia terminal 100 to the “VIDEO ON” mode (for example, the flip up state if the terminal is a flip type; the unfolded state if the terminal is a folder type), the multimedia terminal 100 transmits the SET_PARAMETER message of the “VIDEO ON” command to the media server 200 according to the change of mode. Then, the media server 200 transmits a stream including the video data to the multimedia data in response to the SET_PARAMETER message, so that the video of the contents is played back (S26, S27, S29).

Thereafter, if the user selects the “VIDEO OFF” mode again, the multimedia terminal 100, like the step S25, transmits the SET_PARAMETER message to turn off the video. Unlike this, if there is no change of mode, the current state is maintained until the playback of the contents is completed (S28 & S30).

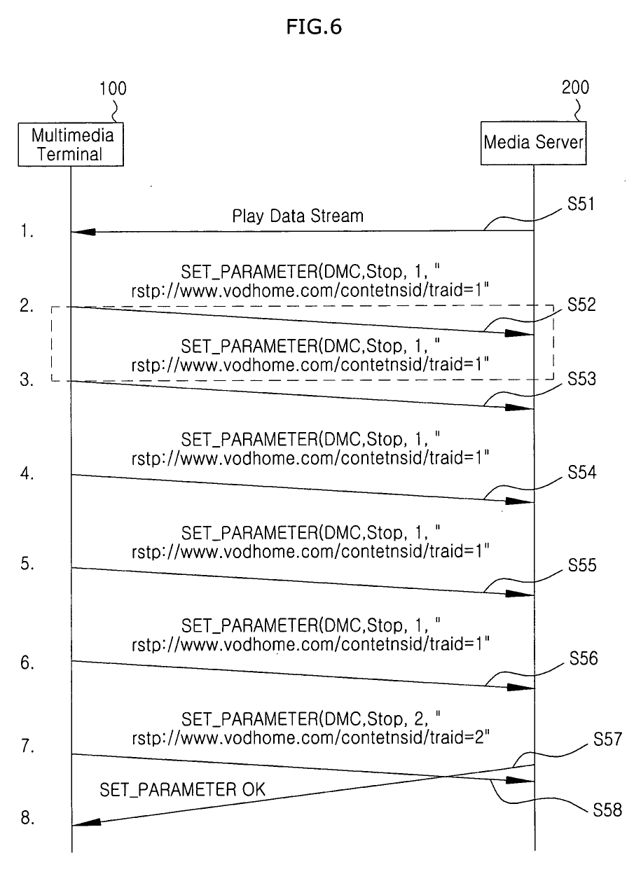

Hereinafter, referring to FIGS. 5 and 6, the method for controlling multimedia based on RTSP in a wireless data communication network according to a second embodiment of the present invention will be explained in more detail.

As discussed above, the embodiments of the present invention presume an environment wherein a streaming session is controlled according to RTSP (Real Time Streaming Protocol), and each streaming data is transmitted according to RTP.

Referring to FIG. 5, if the media server 200, to which the method according to the present invention is applied, receives a media data request from the multimedia terminal 100, the media server 200 transmits the requested media data to the multimedia terminal 100. If the media server 200 receives a command for controlling the media data from the multimedia terminal 100 while the media data are being transmitted to the multimedia terminal 100, the media server 100 controls the media data according to the command. The command is generated at the multimedia terminal 100 through the SET_PARAMETER message of RTSP to be provided to the media server 200. The media data may comprise at least one media depending on the contents. For example, the media data include at least one among video file, audio file, and text file. In addition, the command includes the suspension of transmission or the retransmission for each of the video file, audio file and text file.

The multimedia terminal 100 establishes a session for each media constituting the contents according to RTSP in order to receive the contents, and if the multimedia terminal 100 requests the media server 200 for each media constituting the contents, the media server 200 streams the media data of the contents to the multimedia terminal 100 according to the request.

The multimedia terminal 100 generates a SET_PARAMETER message according to the definition of Table 1 in order to control the media of the contents, and provides the SET_PARAMETER message to the media server.

If the SET_PARAMETER message is generated at the multimedia terminal 100, the media server 200 responds to the message like Table 2 as described above.

The SET_PARAMETER message in Table 2 request the media server 200 for the suspension of the data transmission of TrackID: 1. The media server 200 streams the media data excluding the date of TrackID: 1 to the multimedia terminal 100 according to the SET_PARAMETER message.

Hereinbelow, the method for controlling multimedia based on RTSP in a wireless data communication network according to the present invention will be explained in more detail.

Referring to FIG. 5, the multimedia terminal 100 requests the description of the contents requesting a DESCRIBE message in the TCP session. Then, in response to the DESCRIBE message, the media server 200 provides all the description of each media constituting the contents to the multimedia terminal 100 (S31-S33).

The multimedia terminal 100, which has received the description of the contents in response to the DESCRIBE message from the media server 200, transmits each SETUP request message in order to request desired media, for example, video of TrackID: 1, audio of TrackID: 2, and text of TrackID: 3, according to a user's selection. Then, in response to each SETUP request message, the media server 200 provides a transport mechanism to be used at the time of distributing the requested media to the multimedia terminal 100 (S34-S39).

If the multimedia terminal 100 receives a SETUP message response, the multimedia terminal 100 transmits the PLAY message of requesting the transmission of the media to the media server 200 through a mechanism defined at the SETUP. Then, the media server 200 provides the requested media stream to the multimedia terminal 100 in response to the PLAY message (S40-S42).

During the transmission of the requested media stream, a SET_PARAMETER for controlling the media stream may be generated from the multimedia terminal 100 according to the present invention. For example, the user may need to stop the playback of the media according to the environment while the multimedia terminal 100 is playing back the media. At this time, it is preferable that a player is installed in such a manner that the user can designate the change (stop/start) of the state of the media playback, for example, the user can perceive the type defined at the initial setting to select the stop/start in connection with the track ID from a pop-up menu at the bottom of the playback screen of the multimedia terminal 100. Also, the control menu may be disabled if it falls under the control according to the terminal or playback state. For example, the contents without a specific media are preferably omitted from the menu items or disabled. For example, if a specific terminal has video, audio and text, since the initial menu can selects the change from an “ON” state to an “OFF” state, it is preferable that “VIDEO OFF,” “AUDIO OFF,” and “TEXT OFF” appear. If the video playback is “OFF,” it is preferable that “VIDEO ON,” “AUDIO OFF,” and “TEXT OFF” appear (S66). However, it should be noted that the present embodiment is not limited to the player installed at the multimedia terminal 100.

At the step S43, as shown in Table 2 above, a SET_PARAMETER of requesting the transmission of the video of TrackID: 1 is generated at the multimedia terminal, the media server 200, in response to the SET_PARAMETER, provides the stream of the rest media excluding video TrackID: 1 from the contents to the multimedia terminal 100 according to the command (S43 & S44).

Thereafter, if the user selects the video playback from the menu of the multimedia terminal 100 according to the change of the playback environment, a SET_PARAMETER is generated at the multimedia terminal 100 in response to the command of requesting the retransmission. Then, the media server 100 transmits a stream including video data to the multimedia terminal 100 according to the command (S44 & S45).

In the meantime, if the multimedia terminal 100 does not receive from the media server 200 the response to the SET_PARAMETER message transmitted from the multimedia terminal 100 for a predetermined. time, for example, for three seconds, the multimedia terminal 100 repeatedly transmits the SET_PARAMETER message for a predetermined times, for example, three times, and if there is no response after all, the multimedia terminal 100 operates without further attention (S51-S55). If another SET_PARAMTER is transmitted to the media server 100 from the multimedia terminal 100 while the response to a previous SET_PARAMETER message, a timer and count are reset (S56 & S57).

Accordingly, according to the above constitution, if the user stops a specific media among the entire media constituting the contents according to the description of the contents during the use of the terminal, or if the user does not satisfy the quality, the user can block the media having high volume data arbitrarily. Also, since the user does not receive unnecessary data, the use can save the charge for packets. That is, since the unnecessary traffic is reduced, the wireless network resource and the system resource are saved, resulting in the maximization in efficiency.

As described above, the present invention can achieve a method for controlling multimedia based on RTSP in a wireless data communication network, which can control the media data transmitted according to the receiver's selection during the transmission of media in a wireless data communication network.

While the invention has been described in conjunction with specific embodiments and examples thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for controlling multimedia based on RTSP at a multimedia terminal, comprising the steps of:
(a) confirming the state of the multimedia terminal if a user of a multimedia terminal selects multimedia playback;
(b) generating a PLAY message requesting the selected multimedia data based on the confirmation result at the step (a), and transmitting the generated PLAY message to a media server through a wireless data communication network;
(c) determining whether or not the state of the multimedia terminal has been changed after the step (b); and
(d) transmitting a command message corresponding to the changed state of the multimedia terminal if the state of the multimedia terminal is changed as a result of the determination of the step (c).

2. The method for controlling multimedia based on RTSP at a multimedia terminal according to claim 1, wherein the command message is provided through a SET_PARAMETER message.

3. The method for controlling multimedia based on RTSP at a multimedia terminal according to claim 1, wherein the state of the multimedia terminal includes a vibration mode and a display mode of a phone bell.

4. The method for controlling multimedia based on RTSP at a multimedia terminal according to claim 3, wherein if the state of the multimedia terminal is determined as a mode in which the user cannot see a screen at the step (a), the PLAY message requesting to exclude video data from the multimedia data is generated.

5. The method for controlling multimedia based on RTSP at a multimedia terminal according to claim 4, wherein if the state of the multimedia terminal is determined as a vibration mode in the step (a), the PLAY message requesting to exclude audio data from the multimedia data is generated.

6. The method for controlling multimedia based on RTSP at a multimedia terminal according to claim 1, wherein the command message includes a command of controlling each of at least one media constituting the multimedia.

7. The method for controlling multimedia based on RTSP at a multimedia terminal according to claim 6, wherein if it is determined at the step (c) that the multimedia terminal has been changed to the vibration mode or the vibration-off mode, the command message generated at the step (d) is a request for the stop or start of the transmission of audio media.

8. The method for controlling multimedia based on RTSP at a multimedia terminal according to claim 6, wherein if it is determined at the step (c) that the multimedia terminal has been changed to a visible or invisible mode, the command message generated at the step (d) is a request for the stop or start of the transmission of video media.

9. The method for controlling multimedia based on RTSP at a multimedia terminal according to claim 1, wherein the command message is provided through a SET_PARAMETER message, and the SET_PARAMETER message includes at least one parameter defined for controlling the media.

10. A method for controlling multimedia based on RTSP at a multimedia terminal to distribute multimedia data in a wireless data communication network, comprising the steps of:
(a) transmitting multimedia data, which the multimedia terminal requested according to RTSP, to the multimedia terminal through the wireless data communication network; and
(b) reconstructing the multimedia data according to the command, and transmitting the reconstructed multimedia data to the multimedia terminal, if a command for controlling the multimedia data is generated at the multimedia terminal while the multimedia data is being transmitted to the multimedia terminal at the step (a).

11. The method for controlling multimedia based on RTSP at a multimedia terminal to distribute multimedia data in a wireless data communication network according to claim 10, wherein the command is provided through the SET_PARAMETER.

12. The method for controlling multimedia based on RTSP at a multimedia terminal to distribute multimedia data in a wireless data communication network according to claim 10, wherein the command includes a request for the stop or start of the transmission of the media data.

13. The method for controlling multimedia based on RTSP at a multimedia terminal to distribute multimedia data according to claim 10, the command is defined by at least one parameter of the SET_PARAMETER.

14. The method for controlling multimedia based on RTSP at a multimedia terminal to distribute multimedia data in a wireless data communication network according to claim 10, wherein the media data include at least one among video file, audio file and text file, and the command includes a request for the stop or start of the transmission of each of the video file, audio file and text file.

15. A method for controlling multimedia based on RTSP to distribute multimedia data in a wireless data communication network, comprising the steps of:
(a) receiving a media request from a multimedia terminal to a media server;
(b) transmitting the requested media data to the multimedia terminal if the media request from the multimedia terminal is received; and
(c) controlling the multimedia data according to the command if a command for controlling the multimedia data is generated from the multimedia terminal while the multimedia data is being transmitted to the multimedia terminal, wherein the command is provided through the SET_PARAMETER message; the multimedia data includes at least one among video file, audio file and text file; and the command includes a request for stop or start of the transmission of each of the video file, audio file and text file.

16. The method for controlling multimedia based on RTSP to distribute multimedia data in a wireless data communication network according to claim 15, wherein if there is no response to the command of the multimedia terminal for a predetermined time, the multimedia terminal retransmits the command, and if the retransmission is repeated for a predetermined number of times, the multimedia terminal disregards the transmission of the command.

17. The method for controlling multimedia based on RTSP to distribute multimedia data in a wireless data communication network according to claim 15, wherein the command is defined by at least one parameter of the SET_PARAMETER.

18. A method for controlling multimedia based on RTSP in a wireless data communication network, comprising the steps of:
(a) confirming the state of the multimedia terminal if a user of a multimedia terminal selects a multimedia playback;
(b) generating a PLAY message requesting the selected multimedia data based on the confirmation result at the step (a), and transmitting the generated PLAY message to a media server through a wireless data communication network;
(c) transmitting multimedia data from the media server to the multimedia terminal according to the PLAY message if the media server receives the PLAY message from the multimedia terminal;
(d) determining whether the state of the multimedia terminal is changed after the step (b);
(e) generating a SET_PARAMETER corresponding to the changed state, and transmitting the SET_PARAMETER to the media server if the state of the multimedia terminal is changed as a result of the determination at the step (c);
(f) controlling the multimedia data according to the SET_if the media server receives the SET_PARAMETER message PARAMETER while the multimedia data are being transmitted to the multimedia terminal at the step (c).

19. The method for controlling multimedia based on RTSP in a wireless data communication network according to claim 18, wherein the state of the multimedia terminal includes a vibration mode or a display mode of phone.

20. The method for controlling multimedia based on RTSP in a wireless data communication network according to claim 18, wherein if it is determined at the step (a) that the state of the multimedia terminal is in a mode that the user cannot see the screen, the PLAY message requesting to exclude video data from the multimedia data is generated.

21. The method for controlling multimedia based on RTSP in a wireless data communication network according to claim 19, wherein if it is determined at the step (a) that the state of the multimedia terminal is in a vibration mode, the PLAY message requesting to exclude audio data from the multimedia data is generated.

22. The method for controlling multimedia based on RTSP in a wireless data communication network according to claim 18, wherein the SET_PARAMETER includes a command of controlling each of at least one media constituting the multimedia.

23. The method for controlling multimedia based on RTSP in a wireless data communication network according to claim 22, wherein if it is determined at the step (d) that the state of the multimedia terminal is changed to a vibration mode or a release mode, the SET_PARAMETER message generated at the step (e) is a request for the stop or start of the transmission of audio media.

24. The method for controlling multimedia based on RTSP at a wireless data communication network according to claim 22, wherein if it is determined at the step (d) that the state of the multimedia terminal is changed to a window-close mode or a window-open mode, the SET_PARAMETER message generated at the step (e) is a request for the stop or start of the transmission of video media.

25. The method for controlling multimedia based on RTSP in a wireless data communication network according to claim 18, wherein the SET_PARATER message includes at least one parameter defined for controlling the media.
